(19) United States
(12) Patent Application Publication
(10) Pub. No.: US 2003/0210700 A1
(43) Pub. Date: Nov. 13, 2003

(54) System and method of dynamically switching between 802.11b client and access point in MS-Windows environment

(75) Inventor: Bofu Chen, Fremont, CA (US)

Correspondence Address: Philip K. Yu, Attorney At Law, 20955 Pathfinder Road, Ste. 100, Diamond Bar, CA, 91765, US

(73) Assignee: AmbiCom, Inc.

(21) Appl. No.: 10/143,398

(22) Filed: May 9, 2002

(51) Int. Cl. G06F 15/16

(52) U.S. Cl. 370/401; 370/338

(57) ABSTRACT

System and method for a configurable application driver for an 802.11 (b) device such as PC card/PCI wireless AP, that can provide both the WC and AP functions in one module. The application driver is designed to perform as either WC or AP driver, according to current setting. The AP is a firmware-based AP, as is typically provided by chipmakers, so as to avoid performance degradation. The application driver also functions as a regular WC driver to put the device into the WC mode. It can then connect to other APs and act as a client network device.

### FIELD OF THE INVENTION

The present invention relates to local wireless networks based on IEEE 802.11b wireless LAN standards and more particularly to its infrastructure and Ad-Hoc connectivity models.

### ART BACKGROUND

With the advent of the Internet, people have become accustomed to accessing information from remote sources through the Internet. However, the “on-ramp” to the Internet, and the World Wide Web, has been confined to only locations equipped with dial-up, DSL, cable modem or T1 connections. Without a connection to the Internet, a user's notebook computer is virtually useless, as far as being able to reach out is concerned. Although mobile phones had become part of our everyday routine, the once-promising cellular-based Web surfing turned out to be quite a disappointment, in large part due to the slow connection speed and the cost associated therewith. Nevertheless, as more and more computer users become “road worriers,” thanks to progress in notebook computing and cell phone technology, they expect being able to connect to the Internet at just about any place they can turn on their computers—at the airport, in the hotel lobby or even at the nearest Starbucks® Coffee.

A wireless LAN communications standard, known as the IEEE 802.11(b) WLAN standard, is the industry's answer to their prayers. By using technology based on the 802.11(b) standard, Access Points (“AP”) can be created, where clients within a radius of about 300 ft can gain wireless access to the Internet by using their notebook computer with an 802.11(b) card. Each AP, at the other end, is connected through wired lines to the backbone network.

As is well known to those in the art, the 802.11(b) Wireless LAN standard defines several Wireless LAN connectivity models, including Infrastructure mode, Ad-Hoc mode, Bridging mode, etc. Currently the most commonly used mode in home/office/school/corporation environment is the Infrastructure mode, which requires an AP, instead of Ad-Hoc operation. The Infrastructure mode, as illustrated in FIG. 1, defines two different wireless nodes. As shown in FIG. 1, one node is AP node A05, which can accept wireless association request and redirect network traffic to backbone network A00. The other node is Wireless Client (“WC”) node A10, A20, A30, which can provide each client system (e.g. laptop, PDA, desktop, etc.) wireless connectivity to AP node A05.

Usually an AP is an embedded system with wireless components and an Ethernet port. The Ethernet port is further connected to backbone network in order to redirect 802.3 packets to associated WCs. The AP also receives packets from WCs and route them to the Ethernet port. Most conventional AP embedded systems are implemented with a CPU or special-designed ASIC chips, and semiconductor components, such as Flash, RAM, Network Interface Card, etc., to implement IEEE 802.11b AP protocol functions and Ethernet port functions.

As can be appreciated by those skilled in the art, the cost of setting up an AP system, including the gateway and the AP, is relatively high, especially when the AP set-up is a stand-alone system, dedicated to providing access point functionality only.

Additionally, such AP implementations have other drawbacks in SOHO (Small Office/Home Office) and school environment, where people share one Internet connection, e.g. V.90 dial-up, cable modem or DSL, and would use the AP as a wireless connectivity hub. FIG. 2 illustrates an exemplary Internet-sharing network topology in such an environment. In this set-up, extra devices, such as IP-sharing (such as Network Address Translation) routers B25, are further required to provide IP-sharing connections to the WCs B40, B45 and B50. However, such NAT routers have no place in the simple AP-Infrastructure mode.

Therefore, both situations, as illustrated by FIG. 1 and FIG. 2, require dedicated up-front investment in systems. For users who prefer flexibility and affordability between the modes, such a dedicated single set-up does not render itself very attractive.

Therefore, it is desirable to provide an affordable connectivity solution to users for both AP and Internet-sharing.

It is also desirable to provide the affordable solution with flexibility and simplicity for AP and Internet-sharing.

It is further desirable to do so by utilizing built-in capability provided in the user's own PC environment.

Some have attempted to address the above needs. A PC-AP from Zoom® Telephonics, Inc. of Boston, Mass., (www.zoom.com) presents AP software running in Windows environment. Together with IP-sharing software from SyGate Technologies (www.sygate.ca), such as SyGate® Home™ v. 4.2, they provide a solution that is based in Windows. However, since it is a software implementation of AP functions in the host side, the performance of the AP system tends to be compromised as the number of connections from WCs grows.

### SUMMARY OF THE INVENTION

Therefore, it is an object of the present invention to provide flexible connectivity AP or WC modes without the need for stand-alone AP in SOHO/school environment.

It is also an object of the present invention to be able to utilize the IP-sharing features in Windows to set up an Infrastructure network with minimal user setting.

The present invention is directed to a configurable application driver, for an 802.11 (b) device such as PC card/PCI wireless AP, that can provide both the WC and AP functions in one module. The application driver is designed to perform as either WC or AP driver, according to current setting. The AP is a firmware-based AP, as is typically provided by chipmakers, so as to avoid performance degradation. The application driver also functions as a regular WC driver to put the device into the WC mode. It can then connect to other APs and act as a client network device.

When the application driver is switched from WC mode to AP mode, the driver downloads the AP firmware to the 802.11 (b) device and turn the device into an AP device. The system will now receive connection requests from other WCs to facilitate wireless network connections. The driver can also handle the network packets to comply with AP function requirements instead of complying with WC requirements.

After the wireless AP mode is enabled from the driver, Windows IP-sharing protocol can also be enabled to provide unique IP addresses to all the WCs connecting to this AP.

If the driver is switched back from AP mode to WC mode, the driver resets the device and restore running firmware function from AP to WC. The driver then changes its internal state accordingly. The system then becomes a wireless client network connection device.

### BRIEF DESCRIPTION OF THE DRAWINGS

FIG. 1 is an exemplary topology of a conventional Wireless LAN infrastructure mode.

FIG. 2 illustrates an exemplary Internet-sharing network topology in a conventional wired and wireless LAN.

FIG. 3(a) illustrates an exemplary Internet-sharing topology with external Ethernet/USB modems in accordance with one embodiment of the present invention.

FIG. 3(b) illustrates an exemplary Internet-sharing topology with external V.90 modems in accordance with one embodiment of the present invention.

FIG. 3(c) illustrates an exemplary Internet-sharing topology with internal V.90 modems in accordance with one embodiment of the present invention.

FIG. 4 illustrates a simplified software block diagram in accordance with one embodiment of the present invention.

FIG. 5 illustrates an exemplary flow diagram of the methodology in accordance with one embodiment of the present invention.

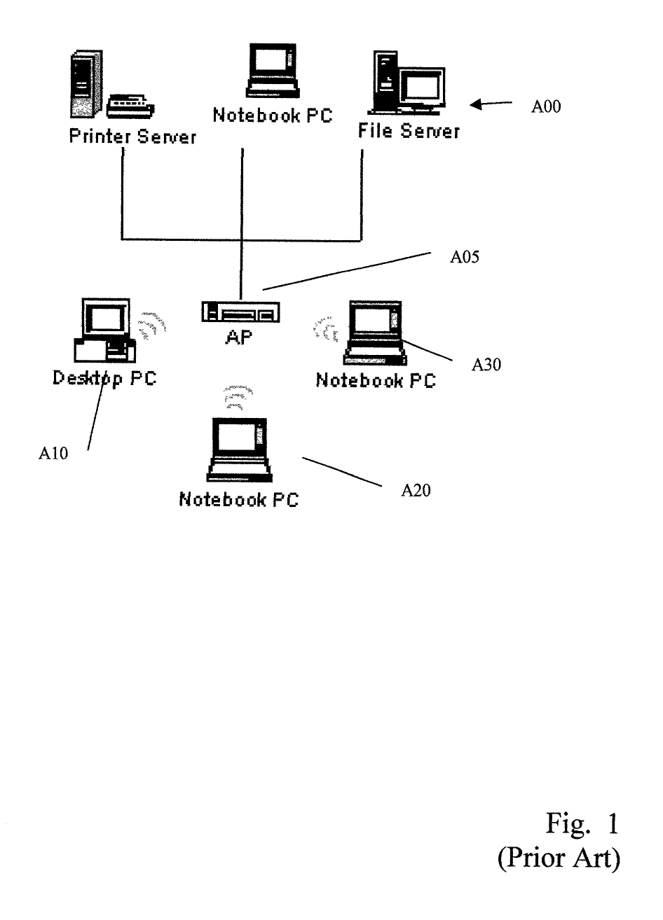

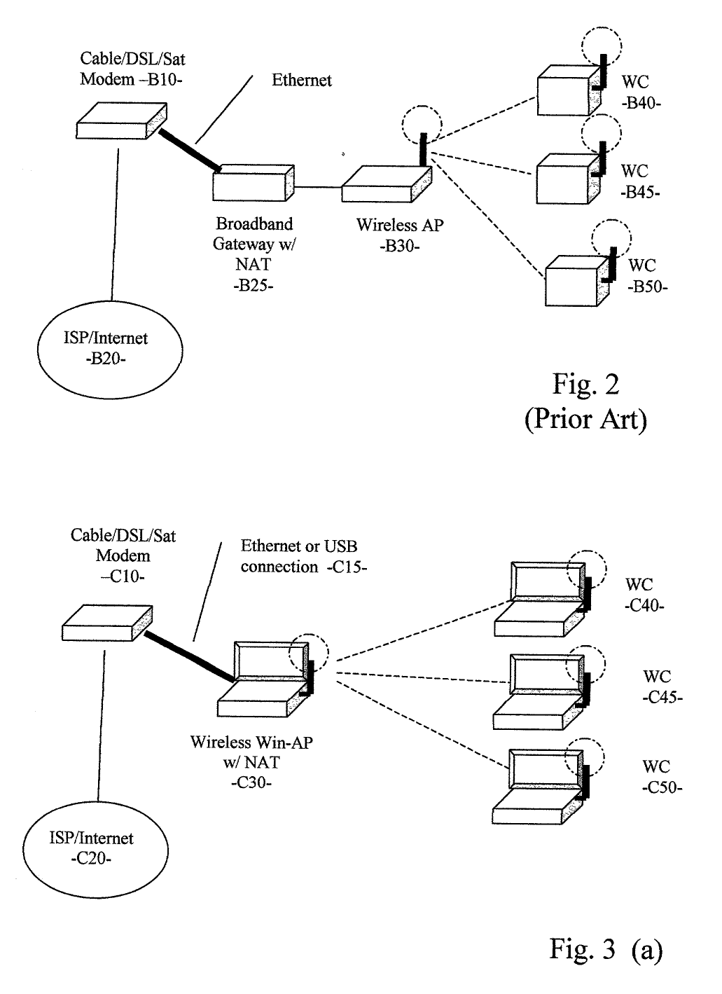

### DETAILED DESCRIPTION OF THE PREFERRED EMBODIMENT

A method and system for dynamically switching between 802.11(b) client and access point in Windows® environment is disclosed. In the following detailed description, numerous specific details are set forth to provide a full understanding of the present invention. It will be obvious, however, to one ordinarily skilled in the art that the present invention may be practiced without some of these specific details. In other instances, well-known structures and techniques have not been shown in detail so as to avoid unnecessarily obscuring the present invention

The present invention is directed to a Windows®-based application driver for providing Wireless LAN 802.11(b) AP functionality without actual AP hardware. When installed into the host system, e.g. a notebook or desk-top computer running Windows operating system, the driver can dynamically convert a Windows 802.11(b) station into an AP with IP-sharing by facilitating Windows built-in NAT capability (Internet Connection Sharing). The driver can also be used in conjunction with any other available NAT software packages (from SyGate® or WinGate) to provide Internet sharing function, while the host system can still be used as an Internet client. It can further be combined with any bridge-function package to provide dedicated AP functionality.

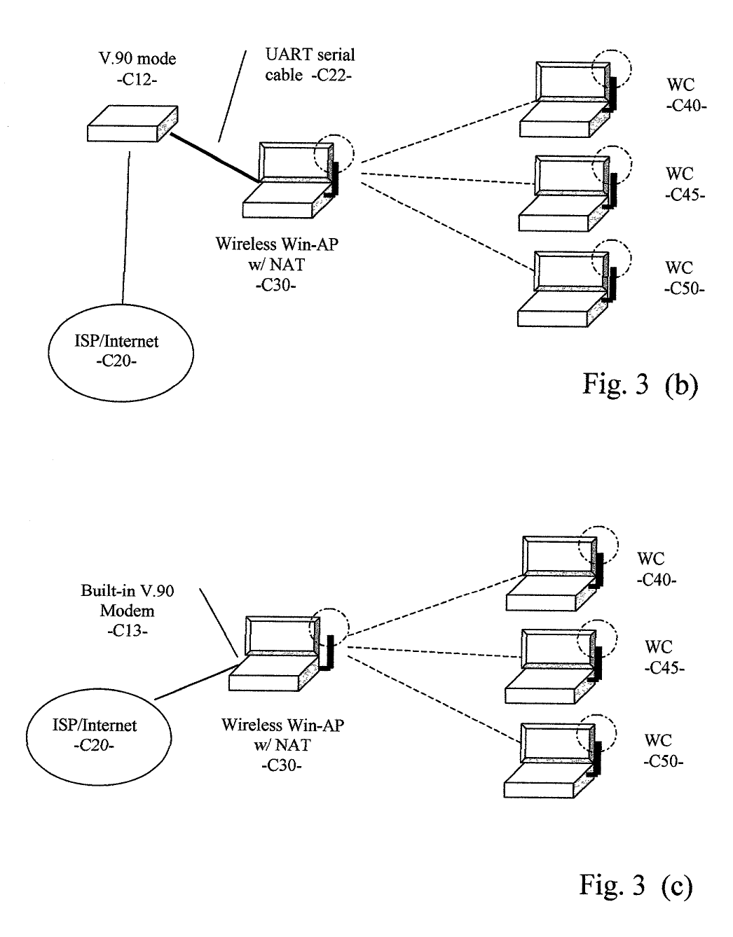

Reference is now directed to FIG. 3(a), where an exemplary Internet-sharing topology with external Ethernet/USB modems in accordance with one embodiment of the present invention is shown. The application driver in accordance with one embodiment of the present invention can now reside in notebook computer C30, which is connected to modem C10 through Ethernet or USB connection C15. Modem C10, which can be a cable, DSL or satellite modem, is further connected to the Internet C20. Notebook C30, which preferably operates on Windows 2000 operating system with TCP/IP protocol, is installed with an 802.11(b) device, which communicates as an AP with other 802.11(b) devices in wireless clients C40, C45, and C50.

The application driver in one embodiment of the present invention also works with other Internet connections, such as V.90 modem, an exemplary topology of which is illustrated in FIG. 3(b). Instead of connecting to the Internet C20 through a high speed digital modem, a V.90 dial-up modem C12 is used to provide the link. V.90 modem C12 is connected to notebook computer C30 through its UART serial cable C22. Notebook computer C30, which is equipped with an 802.11(b) device and the application driver of one embodiment of the present invention, can now operate as an AP for other wireless clients C40, C45 and C50, if the user desires it to be in AP mode.

In recent years, V.90 modems have become internal within a desk-top computer or a notebook computer. This arrangement is shown in FIG. 3(c), which represents a further reduction of hardware from the exemplary topology of FIG. 3(b). As shown, notebook C30, equipped with an 802.11(b) device, can provide an AP to reach the Internet C20, for its wireless clients W40, W45, and W50.

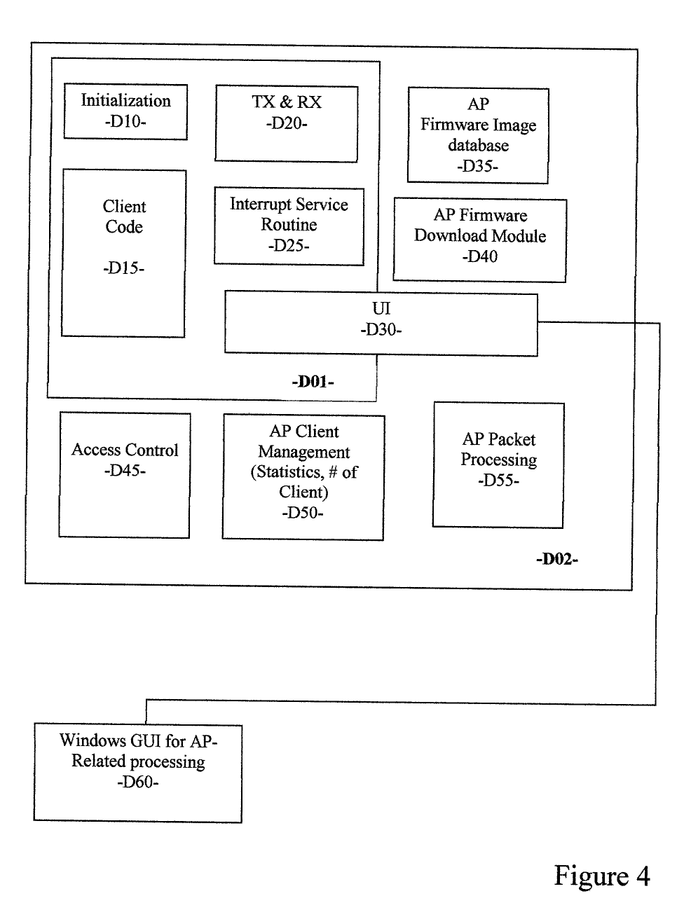

Reference is now turned to FIG. 4, where a simplified functional diagram of the application driver in accordance with one embodiment of the present invention is illustrated. Implemented within the application driver, client software components are symbolically shown within Box D01, which functions are typically provided by 802.11(b) chip vendors, such as INTERSIL or ATMEL. As can be appreciated by those skilled in the art, these functional components are needed for a client card to act as a wireless client. Initialization D10 is to initialize Windows-related parameter set-up and hardware initialization. Client code D15 is to implement 802.11(b) protocol standards for the wireless client. Transmitter and Receiver D20 provides a transmitter and receiver handler routine from the host side to a wireless adapter, which for example may be a PCMCIA or PCI card. Interrupt Service Routine D25 provides a software routine to handle hardware response event, such as hardware interrupt. User Interface (UI) D30 is provided as a Windows graphical user-interface (GUI) program for the user to manipulate lower-level driver and hardware parameters to adapt to different wireless environments.

The functionality of an AP, which can be dynamically switched on, and downloaded upon selection by the user, is provided in Box D02 of the application driver. The shared UI D30 allows the user to set itself up as an AP, which upon activation will recognize and allow the user to choose a mode of operation. If a default mode AP is selected, firmware image is dynamically generated for downloading to the 802.11 (b) device, for example the PC card of the user's host computer. Upon completion, the 802.11(b) device, in conjunction with the host computer, can operate as an AP for the wireless clients.

Referring to Box D02 portion of the application driver, AP firmware D35 provides the access point firmware image which had been prepared to be downloaded onto the 802.11 (b) device, which for example may be a PCMCIA or PCI card. AP firmware download module D40 provides the capability to change the hardware adapter firmware image. Access control D45 is provided in the driver so that client MAC address matching can be performed to control incoming client connection request. AP client management D50 provides a systematic way to manage and monitor client activities. AP package processing D55 is provided to recognize both packet formats so that it can act as an AP. This functionality is provided since the 802.11(b) protocol standard specifies different packet formats from the wireless side, depending on whether it is client mode or AP mode.

Outside of Box D02, Window GUI D60 is an enhanced Windows GUI program so that the user can control and monitor client activity when in AP mode.

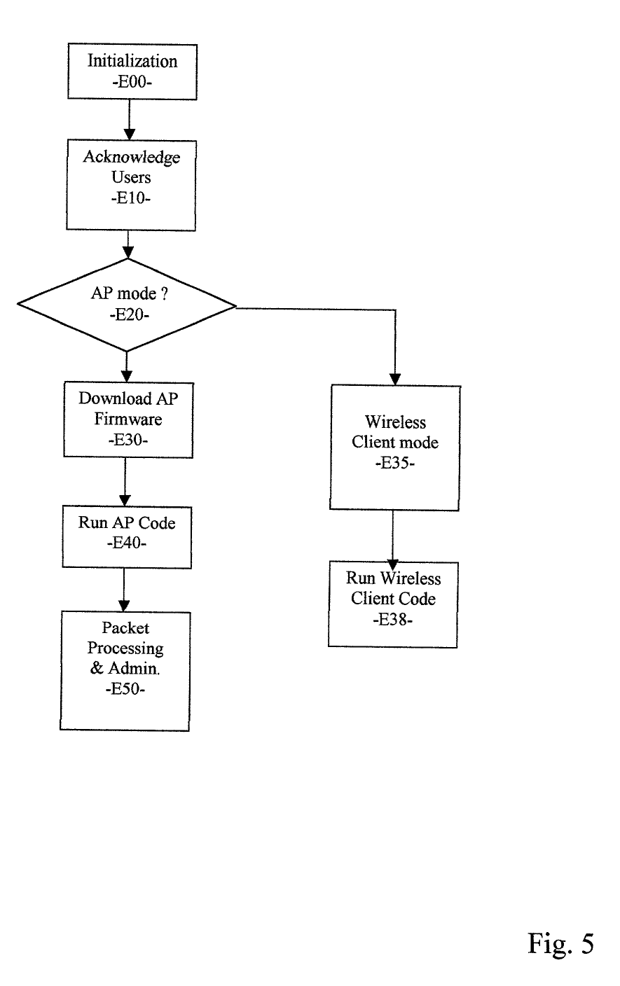

Reference is now turned to FIG. 5, where an exemplary flow diagram of the methodology in accordance with one embodiment of the present invention is illustrated in conjunction with FIG. 4. Upon activation of the driver (block E00), the user is first recognized (block E10) with AP mode set as the default mode. At this step E10, client code module D15 and interrupt service routine D25 can tell the user the current mode and function accordingly.

At block E20, UI module D30 and Windows GUI D60 detect the user's settings and require the other components to run the designated mode.

The user may decide not to operate as an AP. If this is the case, the driver continues to operate the host computer as a WC, by running WC code on the 802.11 (b) device. At step E35, when in client mode, only initialization module D10, client code module D15, Tx & Rx module D20, interrupt service routine D25 and UI D30 will be activated for providing client functions (block E38).

However, if AP mode is set (block E30), AP firmware image module D35 and AP firmware download module D40 will be used to download AP firmware to the adapter.

If the user desires to use the 802.11(b) device as an AP, then the AP firmware is downloaded such that the driver now functions as an AP driver (E40) for the 802.11(b) device and can process and handle the AP packets (E50) between AP and WCs. Here, codes for AP mode will be activated, which preferably include access control module D45, AP client management D50, AP packet processing DS5 and Windows GUI for AP processing D60. Requests from other client cards will now be accepted. At block E50, access control D45, AP client management D50 and Windows GUI D60 are used to administer the packet processing and generate statistics. As should be appreciated by those skilled in the art, there are differences between the ways to process Client packet and to process AP packet. Also, it should be noted that the packet format for AP has been specified by the IEEE 802.11 protocol specifications and such formatting is now implemented in the application driver.

In contrast to the conventional solutions, where the AP functionality is implemented in the driver, the dynamically downloadable AP driver in accordance with one embodiment of the present invention will not compromise the CPU time.

When enabled as an access router, the Windows-based wireless access router (“AR”) in accordance with one embodiment of the present invention can achieve the following features. It provides AR function without the hardware AR cost, such that the user's cost is reduced. Also, the Windows-based AR, which operates as an AP with IP sharing functionality, fully utilizes Windows 2000/XP/98SE/Me built-in IP sharing NAT capability. Further, in terms of user interface, users can perform AR configuration using the UI that is similar to the client UI. For non-broadband devices, the Windows-based AR provides AR functionality to USB-based cable modem/DSL, adapter-based cable modem/DSL, or internal/external V.90 analog modem. Finally, it achieves flexible hardware platform support based on 802.11 (b) PCMCIA or PCI adapters. A simplified comparison between an exemplary Windows-based AR in accordance with one embodiment of the present invention and a hardware wireless router is illustrated below:

| | Win-AR | Hardware Wireless Router |
|---|---|---|
| Platform | Win2000/XP Windows-based | High cost embedded system |
| Environment | AR solution | provides the router |
| | | functionality |
| Requirement | Require only existing | Require power line and |
| | wireless LAN client device | dedicated Ethernet ports |
| Configur- | Windows-based utility for | Web or Windows-based |
| ation | real-time access control | utility |
| Network | Switch between client | Router only |
| mode | and AR | |
| Region | Depending on adapter | Fixed at one region |
| Channels | region | |
| WEP | Open, 40-bit, 128-bit | Open, 40-bit, 128-bit |
| security | encryption | encryption |
| Access | Real-time, MAC-address | Limited |
| control | based access control | |
| Status | Real-time | Snapshot |
| Report | | |
| Bridging | Ethernet, USB, PCI, IEEE | Ethernet only |
| Device | 1394, Gigabit, Dial-up | |
| | modem, etc. | |
| IP-sharing | Windows built-in | Wireless router model |
| | | only; wireless AP does |
| | | not support. |

Although the invention is described herein with reference to the preferred embodiment, one skilled in the art will readily appreciate that other applications may be substituted for those set forth herein without departing from the scope of the present invention. Accordingly, the invention should only be limited by the claims included below.

What is claimed is:

1. A method of operating an access router for a plurality of wireless clients (“WC”) to access the Internet, comprising:
a) providing a host computer;
b) operating said host computer using a Windows operating system, said operating system being adapted to provide TCP/IP and IP sharing functionality to said host computer;
c) operatively connecting an 802.11(b) AP device to said host computer;
d) initializing said 802.11(b) AP device;
e) acknowledging setting of said host computer;
f) if AP mode is selected, downloading AP firmware from said 802.11(b) AP device to said host computer;
g) operating said 802.11(b) AP device as an access router for said plurality of WC with said IP sharing functionality.

2. The method of claim 1, further comprising the steps of:
formatting packets going from said 802.11(b) AP device to said WCs;
formatting packets going from said WCs to said 802.11(b) AP device.

3. The method of claim 1, further comprising the steps of: connecting said host computer to the Internet using one of USB cable modem, USB DSL modem, UART V.90 modem, PCI adapter V.90 modem, Firewire IEEE 1394 connection and Ethernet-based network devices.

4. The method of claim 2, further comprising the steps of: connecting said host computer to the Internet using one of USB cable modem, USB DSL modem, UART V.90 modem, PCI adapter V.90 modem, Firewire IEEE 1394 connection and Ethernet-based network devices.

5. The method of claim 1, wherein said IP sharing functionality is provided by Windows' built-in Internet Connection Sharing feature.

6. The method of claim 1, wherein said IP sharing functionality is provided by using one of SyGate's NAT software and WinGate's NAT software.

7. The method of claim 1, wherein said 802.11(b) AP device is programmed with an application driver, said application driver comprising:
AP firmware database for providing AP firmware image;
AP firmware download module for changing said 802.11 (b) AP device firmware image using AP firmware image from said AP firmware database;
Access control means for controlling incoming client connection requests;
AP client management means for managing client activities;
AP packet processing means for processing packets for AP mode and for client mode.

8. The method of claim 3, wherein said 802.11(b) AP device is programmed with an application driver, said application driver comprising:
AP firmware database for providing AP firmware image;
AP firmware download module for changing said 802.11 (b) AP device firmware image using AP firmware image from said AP firmware database;
Access control means for controlling incoming client connection requests;
AP client management means for managing client activities;
AP packet processing means for processing packets for AP mode and for client mode.

9. The method of claim 4, wherein said 802.11(b) AP device is programmed with an application driver, said application driver comprising:
AP firmware database for providing AP firmware image;
AP firmware download module for changing said 802.11 (b) AP device firmware image using AP firmware image from said AP firmware database;
Access control means for controlling incoming client connection requests;
AP client management means for managing client activities;
AP packet processing means for processing packets for AP mode and for client mode.

10. An access router (“AR”) for connecting a plurality of wireless clients to a global computer information network, comprising:
a host computer;
a Windows operating system adapted to operate said host computer, and to operatively connect said host computer to said global computer information network;
a wireless LAN device operatively connected to said host computer, said wireless LAN device being adapted to enable said host computer in 802.11(b) standard communication;
a software driver adapted to operate said wireless LAN device and said host computer, said software driver being adapted to enable access point functionality of said wireless LAN device and to enable IP sharing functionality of said Windows operating system.

11. The AR of claim 10, wherein said software driver is adapted to perform the following steps:
a) initializing said wireless LAN device;
b) acknowledging setting of said host computer;
c) if AP mode is selected, downloading AP firmware from said wireless LAN device to said host computer;
d) running said wireless LAN device as AP with IP sharing;
e) processing AP packets between said host computer and said WCs.

12. The AR of claim 10, further comprising network connection means to provide access to said global computer information network.

13. The AR of claim 11, further comprising network connection means to provide access to said global computer information network.

14. The AR of claim 11, wherein said network connection means is one of USB cable modem, USB DSL modem, UART V.90 modem, PCI adapter V.90 modem, Firewire IEEE 1394 connection and Ethernet-based network devices, which is operatively connected to said host computer.

15. The AR of claim 14, wherein said Windows operating system enables said IP-sharing functionality using one of Microsoft's Internet Connection Sharing, SyGate and WinGate software tools.

16. The AR of claim 10, wherein said software driver comprises:
AP firmware database for providing AP firmware image;
AP firmware download module for changing said 802.11 (b) AP device firmware image using AP firmware image from said AP firmware database;
Access control means for controlling incoming client connection requests;
AP client management means for managing client activities;
AP packet processing means for processing packets for AP mode and for client mode.

17. The AR of claim 14, wherein said software driver comprises:
AP firmware database for providing AP firmware image;
AP firmware download module for changing said 802.11 (b) AP device firmware image using AP firmware image from said AP firmware database;
Access control means for controlling incoming client connection requests;
AP client management means for managing client activities;
AP packet processing means for processing packets for AP mode and for client mode.

18. A method of using a host computer to connect a plurality of 802.11 (b)-standards wireless clients to the Internet, comprising the steps of:
a) operating said host computer using a Windows operating system;
b) configuring said Windows operating system to enable Internet access functionality and IP sharing functionality;
c) operating said host computer to access the Internet using said Windows operating system;
d) connecting an 802.11 (b) access point (“AP”) device to said host computer
e) initializing said 802.11 (b) AP device;
f) if AR mode is selected, downloading AP firmware from said AP device;
g) operating said host computer as an access point for said plurality of 802.11 (b) wireless clients using said 802.11 (b) AP device, using said IP sharing functionality of said Windows operating system;
h) formatting packets based on a predetermined AP packet format according to said 802.11 (b) standards.

19. The method of claim 18, wherein said AP device comprises:
AP firmware database for providing AP firmware image;
AP firmware download module for changing said 802.11 (b) AP device firmware image using AP firmware image from said AP firmware database;
Access control means for controlling incoming client connection requests;
AP client management means for managing client activities;
AP packet processing means for processing packets for AP mode and for client mode.
